(19) United States
(12) Patent Application Publication
(10) Pub. No.: US 2018/0260531 A1
(43) Pub. Date: Sep. 13, 2018

(54) TRAINING RANDOM DECISION TREES FOR SENSOR DATA PROCESSING

(71) Applicant: Microsoft Technology Licensing, LLC, Redmond, WA (US)

(72) Inventors: Aditya Vithal Nori, Cambridge (GB); Antonio Criminisi, Cambridge (GB); Siddharth Ancha, Toronto (CA); Loïc Le Folgoc, Cambridge (GB)

(21) Appl. No.: 15/456,468

(22) Filed: Mar. 10, 2017

(51) Int. Cl. G06F 19/00; G06N 99/00

(52) U.S. Cl. CPC G06F 19/3437; G06F 19/321; G06N 99/005

(57) ABSTRACT

A method of training a random decision tree to give improved generalization ability is described. At a split node of the random decision tree a plurality of training sensor data elements available at the split node are divided into a tuning set and a validation set. A plurality of models is formed using the tuning set, each model using different values of parameters of the split node. Performance of the models at splitting the validation set between left and right child nodes of the split node is computed and used to select one of the models.

### BACKGROUND

Machine learning technology using random decision trees and random decision forests, which are collections of random decision trees, is used for a variety of tasks such as gesture recognition, object recognition, automatic organ detection, speech recognition, calculating positions of human body joints from depth images, and other tasks. The random decision trees are trained using training examples comprising labeled sensor data during a training phase. During a test phase, sensor data which has not previously been available to the random decision tree or forest is processed using the trained tree or forest. The trained tree or forest computes, from a new sensor data example during the test phase, a prediction such as a predicted class of the new sensor data example, or a predicted regressed value. This is useful for many applications such as semantic image segmentation, face recognition, medical image analysis, speech recognition, gesture detection and other applications.

Random decision trees and forests are complex and time consuming to train. Also, the training process often results in over fitting whereby the resulting trained random decision tree or forest performs well on new examples which are similar to examples used during training, but is unable to cope well with examples which are dissimilar to those used during training. Such machine learning systems may have limited accuracy and/or generalization ability. Generalization ability is being able to accurately perform the task in question even for examples which are dissimilar to those used during training.

Large numbers of training examples are typically used to train random decision trees or random decision forests in order to carry out classification tasks such as human body part classification from depth images or gesture recognition from human skeletal data, or regression tasks such as joint position estimation from depth images. The training process is typically time consuming and resource intensive.

The embodiments described below are not limited to implementations which solve any or all of the disadvantages of known systems for training random decision trees or forests.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A method of training a random decision tree to give improved generalization ability is described. At a split node of the random decision tree a plurality of training sensor data elements available at the split node are divided into a tuning set and a validation set. A plurality of models is formed using the tuning set, each model using different values of parameters of the split node. Performance of the models at splitting the validation set between left and right child nodes of the split node is computed and used to select one of the models.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a plurality of different systems in which a machine learning system with random decision trees/forests is used;

FIG. 2 is a schematic diagram of a random decision tree used to classify image patches from two photographs as belonging to grass, cow or sheep classes;

FIG. 3 is a flow diagram of a method of learning split node parameters during training of a random decision tree;

FIG. 4 is a flow diagram of a method of training a random decision forest;

FIG. 5 is a flow diagram of a method of training and pruning a random decision tree;

FIG. 6 is a flow diagram of a method of using a trained random decision forest at test time;

FIG. 7 illustrates an exemplary computing-based device in which embodiments of a random decision tree and/or a training logic for training the random decision tree is implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

A machine learning system is a computer-implemented apparatus which is able to learn from examples either during an online training process or through offline training by updating data structures using update procedures in the light of the examples.

Various examples are described herein which improve the generalization ability of random decision trees/forests especially in applications where little training data is available. For example, medical image processing is one such application since few medical images are available which have been labeled by medical professionals and it is very difficult to generate accurate training data synthetically. Having said that, the examples described herein are useful to improve generalization ability of random decision trees/forest for many applications.

One approach to dealing with overfitting is to use many randomized random decision trees in a forest and to aggregate the results from the trees in the forest. This helps to give generalization ability. However, there are many applications where it is not practical to use large forest sizes because of limited processing and memory resources and/or because of the need to reduce latency at test time (since for larger forests there are more nodes to traverse at test time). One such application domain is medical image segmentation which typically requires large trees to be grown such as trees of depth 20 to 30 layers and with millions of nodes. Due to computational constraints few such trees can be trained (a few dozen at most) so that model averaging across randomized trees is insufficient to balance tree overfitting. The examples described herein enable generalization to be achieved even where relatively few training examples are available and/or where large forest sizes are not practical.

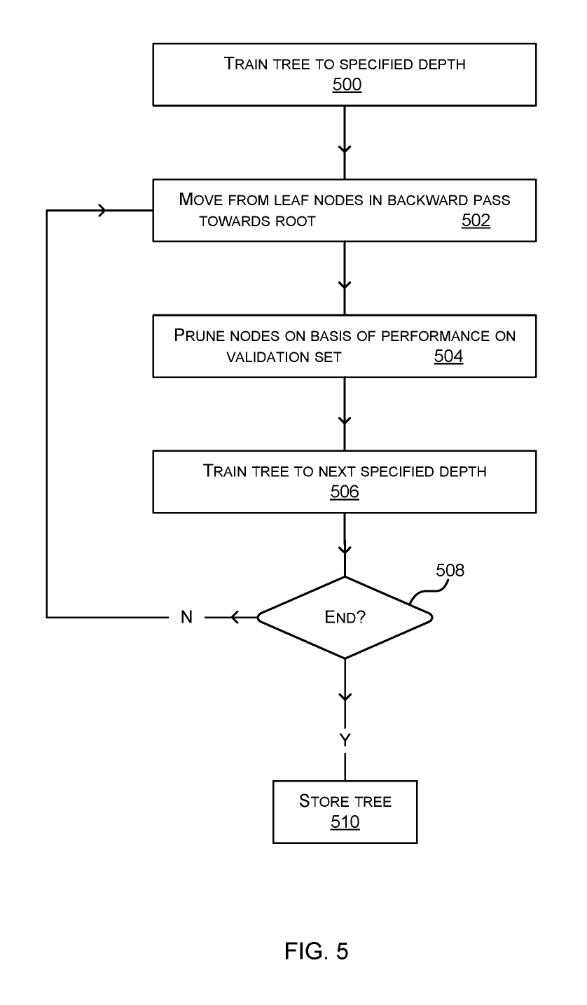

It is recognized herein that overfitting often occurs when random decision trees are allowed to grow during training in a manner which is not appropriately controlled. Various examples described herein with reference to FIG. 5 teach a principled method for controlling capacity of a random decision forest in order to achieve good generalization ability.

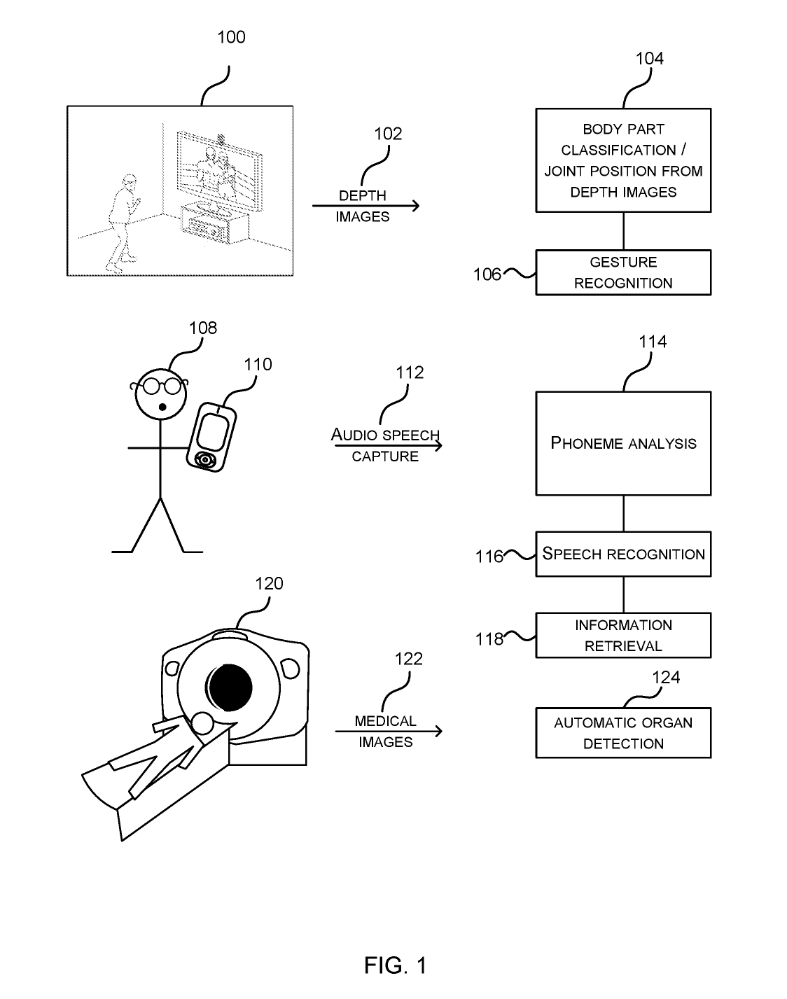

The present technology may be implemented in a variety of different types of application as now described with reference to FIG. 1. In the examples of FIG. 1 a machine learning system using random decision trees/forests is used for classification or regression and where parameters used at the split nodes of the trees are learnt during training in a manner which improves generalization ability. This gives better accuracy as compared with previous systems using random decision trees/forests trained in a conventional manner. In addition, the number of decision trees within a forest may be reduced whilst retaining good generalization ability. This reduces the amount of memory needed to store the trained random decision forest and it also reduces the number of nodes to be traversed at test time, so reducing test time latency.

FIG. 1 is a schematic diagram of a plurality of systems in which a machine learning system with random decision trees/forests is used. For example, a body part classification or joint position detection system 104 operating on depth images 102. The depth images may be from a natural user interface of a game device as illustrated at 100 or may be from other sources. The body part classification or joint position information may be used to calculate gesture recognition 106.

In another example, a person 108 with a smart phone 110 sends an audio recording of his or her captured speech 112 over a communications network to a machine learning system 114 that carries out phoneme analysis. The phonemes are input to a speech recognition system 116 which uses random decision trees/forests. The speech recognition results are used for information retrieval 118. The information retrieval results may be returned to the smart phone 110.

In another example medical images 122 from a computerized tomography (CT) scanner 120, magnetic resonance imaging (MRI) apparatus or other device are used for automatic organ detection 124. Each medical image may comprise many millions of voxels so that the scale of processing involved is significant.

A random decision tree comprises a root node, a plurality of split nodes and a plurality of leaf nodes. The root node is connected to the split nodes in a hierarchical structure, so that there are layers of split nodes, with each split node branching into a maximum of two nodes and where the terminal nodes are referred to as leaf nodes. Each split node has associated split node parameters. Values of split node parameters are learnt during training. The parameters specify types of features to be used and thresholds associated with a binary test. During training, labeled training data accumulates at the leaf nodes and is stored in an aggregated form.

In the case of image processing, image elements of an image may be pushed through a trained random decision tree in a process whereby a decision is made at each split node. The decision may be made according to characteristics of the image element and characteristics of test image elements displaced therefrom by spatial offsets specified by the parameters at the split node. At a split node the image element proceeds to the next level of the tree down a branch chosen according to the results of the decision. This process continues until a leaf node is reached and distributions of labeled image elements which were accumulated at the leaf node during training are retrieved and used to compute a prediction such as a predicted label for the test image element.

Other types of examples may be used rather than images. For example, phonemes from a speech recognition pre-processing system, or skeletal data produced by a system which estimates skeletal positions of humans or animals from images. In this case test examples are pushed through the random decision tree. A decision is made at each split node according to characteristics of the test example and of a split function having parameter values specified at the split node.

The examples comprise sensor data, such as images, or features calculated from sensor data, such as phonemes or skeletal features.

An ensemble of random decision trees may be trained and is referred to collectively as a random decision forest. At test time, image elements (or other test examples) are input to the trained forest to find a leaf node of each tree. Data accumulated at those leaf nodes during training may then be accessed and aggregated to give a predicted regression or classification output. Due to the use of random selection of possible candidates for the split node parameters during the training phase, each tree in the forest has different parameter values and different accumulated data at the leaf nodes. By aggregating the results across trees of the forest improved accuracy and generalization ability is found.

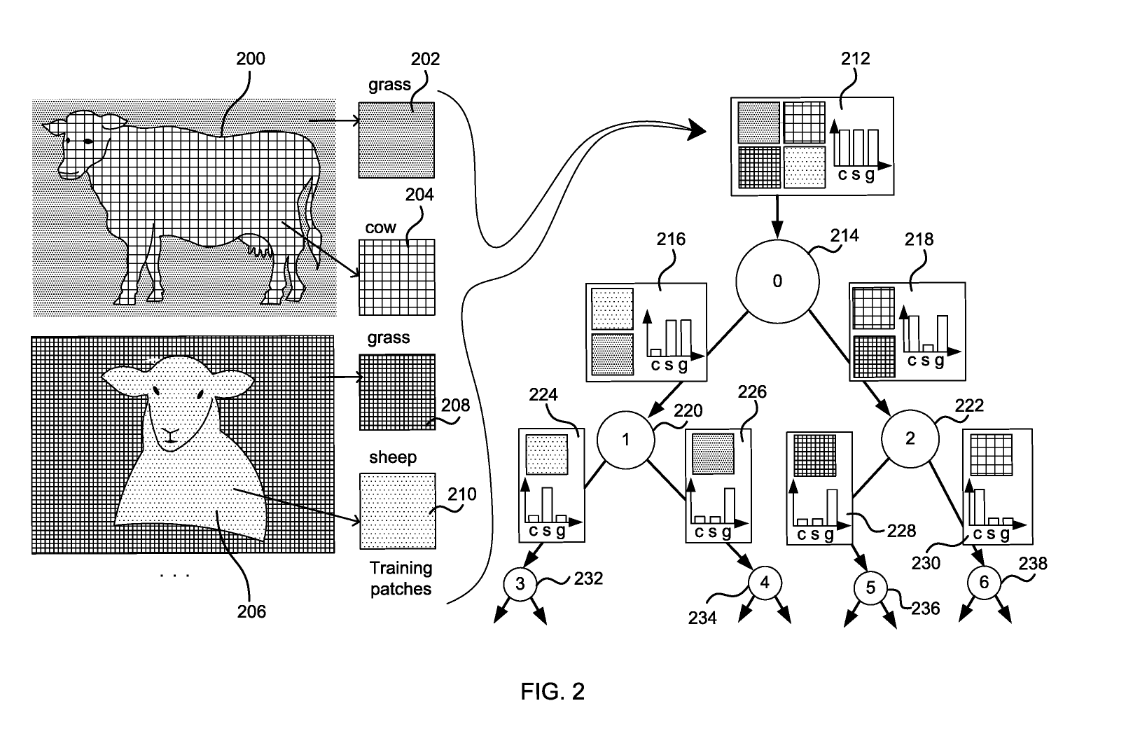

FIG. 2 is a schematic diagram of a random decision tree used to classify image patches from two photographs as belonging to grass, cow or sheep classes. This example illustrates how values of parameters of split functions used at the split nodes influence pathways of sensor data through the random decision tree at test time and so influence the predictions computed.

A photograph of a cow 200 standing in a grassy field is represented schematically in FIG. 2. A photograph of a sheep 206 sitting in a different grassy field is also represented schematically in FIG. 2. Four image patches 202, 204, 208, 210 are taken from the photographs and are input to a trained random decision tree for classification as belonging to grass, cow or sheep classes. The image patches have different color, intensity and texture from one another. The image patch 202 from the grass in the cow photograph is a different from the image patch 208 from the grass in the sheep photograph.

The image patches are input to a root node 214 of the random decision tree as indicated at 212. A parameterized split function at the root node is applied to the image patches and results in the sheep patch 210 from the sheep photograph and the grass patch 202 from the cow photograph being input to node 220 as indicated at 216. The cow patch 204 and the grass patch 210 from the sheep photograph are input to node 222 as indicated at 218. FIG. 2 shows a histogram at each of the split nodes. These are normalized histograms of the training labels reaching these nodes.

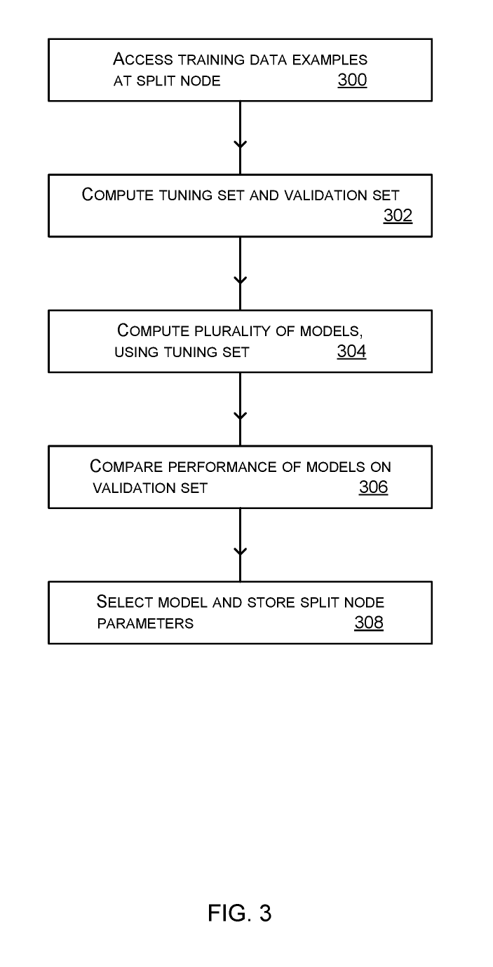

Parameterized split functions at each of split nodes 220 and 222 are applied. Suppose the split node parameter values are such that this results in the sheep patch from the sheep photograph reaching node 232 as indicated at 224 and the grass patch from the cow photograph reaching node 234 as indicated at 226. The grass patch from the sheep photograph reaches node 236 as indicated. The cow patch reaches node 238 as indicated. Thus the values of the parameters of the split functions are important for determining pathways of the sensor data through the random decision forest. The values of the parameters of the split functions are learnt during training where training images patches are used which are labeled according to whether they depict sheep, cow or grass. In various examples a cross-validation process is used at the individual split nodes to facilitate learning the split node parameters in a manner which gives generalization ability. If over-fitting occurs, the random decision forest of FIG. 2 may be presented with a grass image patch which is dissimilar to that of patches 202 and 208 and due to overfitting, the random decision forest is unable to classify the incoming patch as depicting grass. More detail about the cross validation process used at the split nodes during training is now given with reference to FIG. 3.

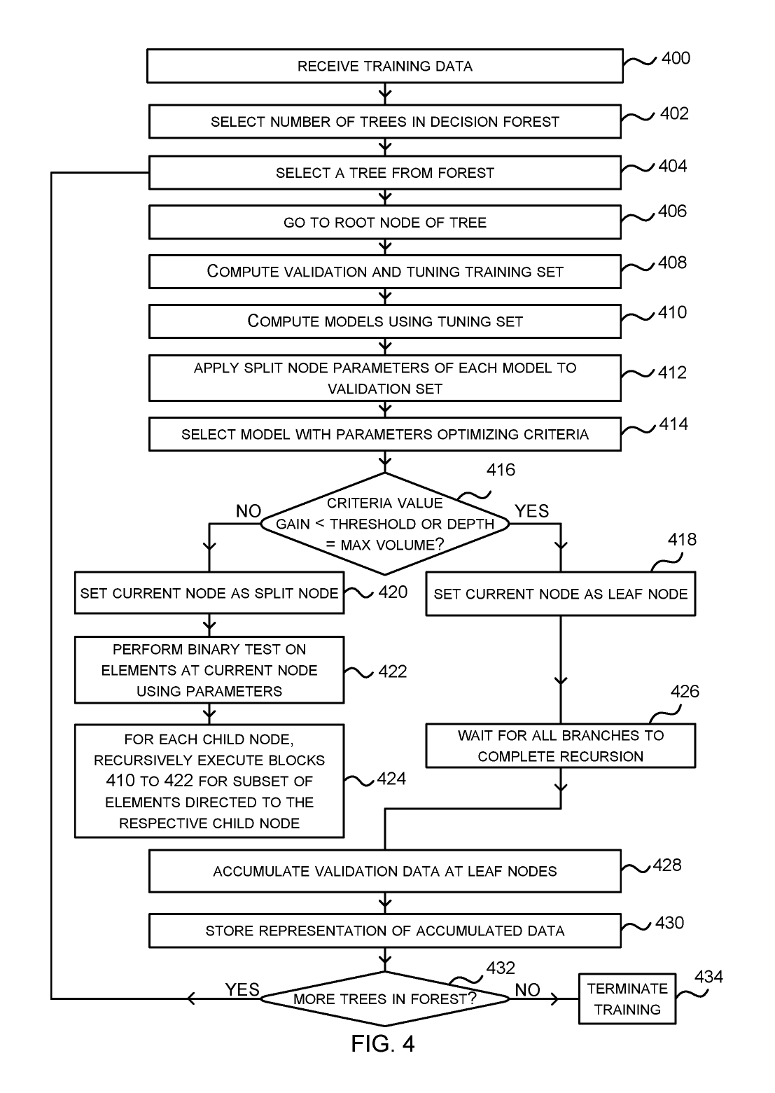

During a training process (explained below with reference to FIG. 4) for training a random decision tree, the process passes each split node of the tree and assigns values to split node parameters at that split node. The flow diagram of FIG. 3 is concerned with the process of assigning values to the split node parameters at an individual split node. Training data examples have reached the split node during the training process (as explained below with reference to FIG. 4) and these are accessed 300. The training data examples are sensor data items which are labeled with ground truth labels, such as body organ classes or other labels. A tuning set and a validation set is computed 302 from the accessed training examples. This is done by randomly dividing the training data examples into two disjoint sets, a tuning set and a validation set. The tuning set and the validation set comprise a plurality of training examples and are not the empty set.

Using the tuning set, a plurality of models are computed 304. Each model is a set of values of the split node parameters for the split node. For example, indicators of which features are to be used and what values of thresholds are to be used in a binary test performed at the split node. The models may be computed by randomly selecting sets of values of the split node parameters and comparing performance of these sets of values at splitting the tuning data between the left and right child nodes of the split node. The performance may be measured using any suitable metric such as information gain, variance reduction, Gini entropy, or the ‘two-ing’ criterion. Combinations of one or more of: the information gain, variance reduction, Gini entropy or the two-ing criterion may be used. The top n performing models are selected and retained for use in the rest of the process of FIG. 3.

The method proceeds to compare 306 the performance of the selected models at splitting the validation set between the left and right child nodes of the split node. The performance is assessed using any suitable metric such as information gain, variance reduction, Gini entropy, or the ‘two-ing’ criterion. Combinations of one or more of: the information gain, variance reduction, Gini entropy or the two-ing criterion may be used. One of the models is selected and stored for use as the split node parameters for the node. The process of FIG. 3 repeats for other split nodes of the random decision tree.

Information gain can be computed by calculating the entropy of the training examples at the split node minus a weighted sum of the entropy of the training examples which reach the left and right child nodes.

Gini entropy is a measure of how often a randomly chosen element from the training data would be incorrectly labeled if it was randomly labeled according to the distribution of labels in the subset.

FIG. 4 is a flow diagram of a computer-implemented method of training a random decision forest and where the process of FIG. 3 is part of the process of FIG. 4. Training data is accessed 400 such as medical images which have labels indicating which body organs they depict, speech signals which have labels indicating which phonemes they encode, depth images which have labels indicating which gestures they depict, or other training data.

The number of decision trees to be used in a random decision forest is selected 402. A random decision forest is a collection of deterministic decision trees. Decision trees can be used in classification or regression algorithms, but can suffer from over-fitting, i.e. poor generalization. However, an ensemble of many randomly trained decision trees (a random forest) yields improved generalization. During the training process, the number of trees is fixed.

A decision tree from the decision forest is selected 404 and the root node is selected 406. A validation set and a tuning set are computed 408 as described above with reference to operation 302 of FIG. 3.

Using the tuning set, a plurality of models are computed 410. The models are computed as described with reference to operation 304 of FIG. 3. Each model comprises values of split node parameters for use by a binary test performed at the node. For example, in the case of images, the parameters may include types of features and values of distances. The features may be characteristics of image elements to be compared between a reference image element and probe image elements offset from the reference image element by the distances. The parameters may include values of thresholds used in the comparison process. In the case of audio signals the parameters may also include thresholds, features and distances.

Then, every model is applied 412 to the validation set. For each combination, criteria (also referred to as objectives) are calculated. In an example, the calculated criteria comprise the information gain (also known as the relative entropy). The combination of parameters that optimize the criteria (such as maximizing the information gain) is selected 414 and stored at the current node for future use. As an alternative to information gain, other criteria can be used, such as variance reduction, Gini entropy, or the ‘two-ing’ criterion or others.

It is then determined 416 whether the value for the calculated criteria is less than (or greater than) a threshold. If the value for the calculated criteria is less than the threshold, then this indicates that further expansion of the tree does not provide significant benefit. This gives rise to asymmetrical trees which naturally stop growing when no further nodes are beneficial. In such cases, the current node is set 418 as a leaf node. Similarly, the current depth of the tree is determined (i.e. how many levels of nodes are between the root node and the current node). If this is greater than a predefined maximum value, then the current node is set 418 as a leaf node. Each leaf node has sensor data training examples which accumulate at that leaf node during the training process as described below.

It is also possible to use another stopping criterion in combination with those already mentioned. For example, to assess the number of example sensor data elements that reach the leaf. If there are too few examples (compared with a threshold for example) then the process may be arranged to stop to avoid overfitting. However, it is not essential to use this stopping criterion.

If the value for the calculated criteria is greater than or equal to the threshold, and the tree depth is less than the maximum value, then the current node is set 420 as a split node. As the current node is a split node, it has child nodes, and the process then moves to training these child nodes. Each child node is trained using a subset of the training sensor data elements at the current node. The subset of sensor data elements sent to a child node is determined using the parameters that optimized the criteria. These parameters are used in the binary test, and the binary test performed 422 on all sensor data elements at the current node. The sensor data elements that pass the binary test form a first subset sent to a first child node, and the sensor data elements that fail the binary test form a second subset sent to a second child node.

For each of the child nodes, the process as outlined in blocks 410 to 422 of FIG. 4 are recursively executed 424 for the subset of sensor data elements directed to the respective child node. In other words, for each child node, new models are generated from the tuning set 410, applied 412 to the validation set of sensor data elements, parameters optimizing the criteria selected 414, and the type of node (split or leaf) determined 416. If it is a leaf node, then the current branch of recursion ceases. If it is a split node, binary tests are performed 422 to determine further subsets of sensor data elements and another branch of recursion starts. Therefore, this process recursively moves through the tree, training each node until leaf nodes are reached at each branch. As leaf nodes are reached, the process waits 426 until the nodes in all branches have been trained. Note that, in other examples, the same functionality can be attained using alternative techniques to recursion.

Once all the nodes in the tree have been trained to determine the parameters for the binary test optimizing the criteria at each split node, and leaf nodes have been selected to terminate each branch, then sensor data training examples may be accumulated 428 at the leaf nodes of the tree. This is the training level and so particular sensor data elements which reach a given leaf node have specified labels known from the ground truth training data. A representation of the accumulated labels may be stored 430 using various different methods. Optionally sampling may be used to select sensor data examples to be accumulated and stored in order to maintain a low memory footprint. For example, reservoir sampling may be used whereby a fixed maximum sized sample of sensor data examples is taken. Selection may be random or in any other manner.

Once the accumulated examples have been stored it is determined 432 whether more trees are present in the decision forest (in the case that a forest is being trained). If so, then the next tree in the decision forest is selected, and the process repeats. If all the trees in the forest have been trained, and no others remain, then the training process is complete and the process terminates 434.

Therefore, as a result of the training process, one or more decision trees are trained using training sensor data elements. Each tree comprises a plurality of split nodes storing optimized test parameters, and leaf nodes storing associated predictions. Due to the random generation of parameters from a limited subset used at each node, the trees of the forest are distinct (i.e. different) from each other.

FIG. 5 is a flow diagram of a method of pruning a random decision tree which is used in conjunction with the methods of FIGS. 3 and 4. This method provides a principled way to grow and prune a random decision tree which facilitates generalization ability. A random decision tree is trained 500 to a specified depth. A pruning process then moves 502 from the leaf nodes in a backward pass towards the root. At each split node, the performance of that node on the validation set as computed during the training process of FIGS. 3 and 4 is looked up and the node is pruned on the basis of that performance. For example, if the information gain was below a specified threshold the node is pruned. Once the backward pruning pass is complete, the method proceeds to train the random decision tree to a next specified depth 506. The method repeats from operation 502 unless a decision to end 508 is taken in which case the tree is stored 510. The decision to end is based on a fixed number of iterations or other criteria.

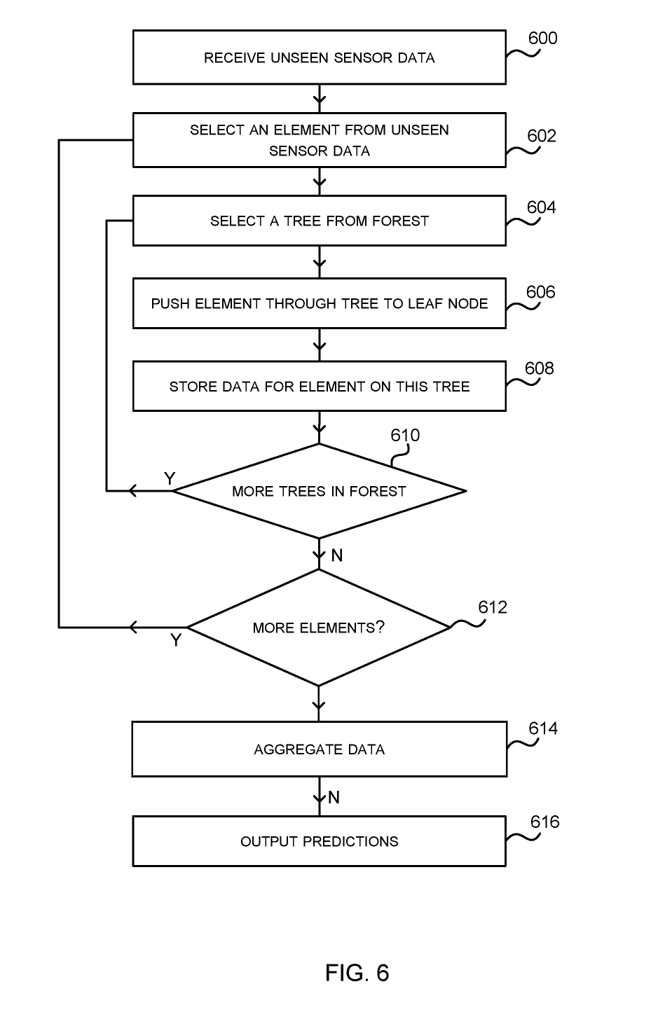

FIG. 6 is a flow diagram of a test time method, of using a trained random decision forest, which has been trained as described herein, to compute a prediction. For example, to recognize a body organ in a medical image, to detect a gesture in a depth image or for other tasks.

Firstly, an unseen sensor data item such as an audio file, image, video or other sensor data item is received 600. Note that the unseen sensor data item can be pre-processed to an extent, for example, in the case of an image to identify foreground regions, which reduces the number of image elements to be processed by the decision forest. However, pre-processing to identify foreground regions is not essential.

A sensor data element is selected 602 such as an image element or element of an audio signal. A trained decision tree from the decision forest is also selected 604. The selected sensor data element is pushed 606 through the selected decision tree such that it is tested against the trained parameters at a split node, and then passed to the appropriate child in dependence on the outcome of the test, and the process repeated until the sensor data element reaches a leaf node. Once the sensor data element reaches a leaf node, the accumulated training examples associated with this leaf node (from the training process) are stored 608 for this sensor data element.

If it is determined 610 that there are more decision trees in the forest, then a new decision tree is selected 604, the sensor data element pushed 606 through the tree and the accumulated leaf node data stored 608. This is repeated until it has been performed for all the decision trees in the forest. Note that the process for pushing a sensor data element through the plurality of trees in the decision forest can also be performed in parallel, instead of in sequence as shown in FIG. 6.

It is then determined 612 whether further unanalyzed sensor data elements are present in the unseen sensor data item, and if so another sensor data element is selected and the process repeated. Once all the sensor data elements in the unseen sensor data item have been analyzed, then the leaf node data from the indexed leaf nodes is looked up and aggregated 614 in order to compute one or more predictions relating to the sensor data item. The predictions 616 are output or stored.

The examples described herein use random decision trees and random decision forests. It is also possible to have some of the split nodes of the random decision trees merged to create directed acyclic graphs and form jungles of these directed acyclic graphs.

It is also possible to implement the random decision trees and forests described herein within a cascaded architecture with a cascade of random decision forests/trees. A cascade of random decision forests comprises one or more levels where output of an earlier level is used as input to a subsequent level and where a level comprises at least one random decision forest. A cascade of random decision trees (as opposed to forests) comprises one or more levels where output of an earlier level is used as input to a subsequent level and where a level comprises at least one random decision tree. In a cascade of random decision forests (or a cascade of random decision trees) the original input data is optionally available to subsequent layers. In the case where the subsequent layer(s) have more than one random decision tree/forest the individual random decision trees or forests may be trained using clustered training data. Clustered training data is training data that is divided into clusters, each cluster holding related data. In this way a random decision tree/forest trained using a cluster of data becomes specialized with respect to that cluster of data, as compared with other random decision trees/forests trained with other clusters of training data.

Using a cascade of random decision trees/forests brings reduced computation at test time as compared with an equivalent random decision tree/forest which is not cascaded. This is because fewer nodes are traversed when the sensor data elements are processed by the cascade of random decision forests.

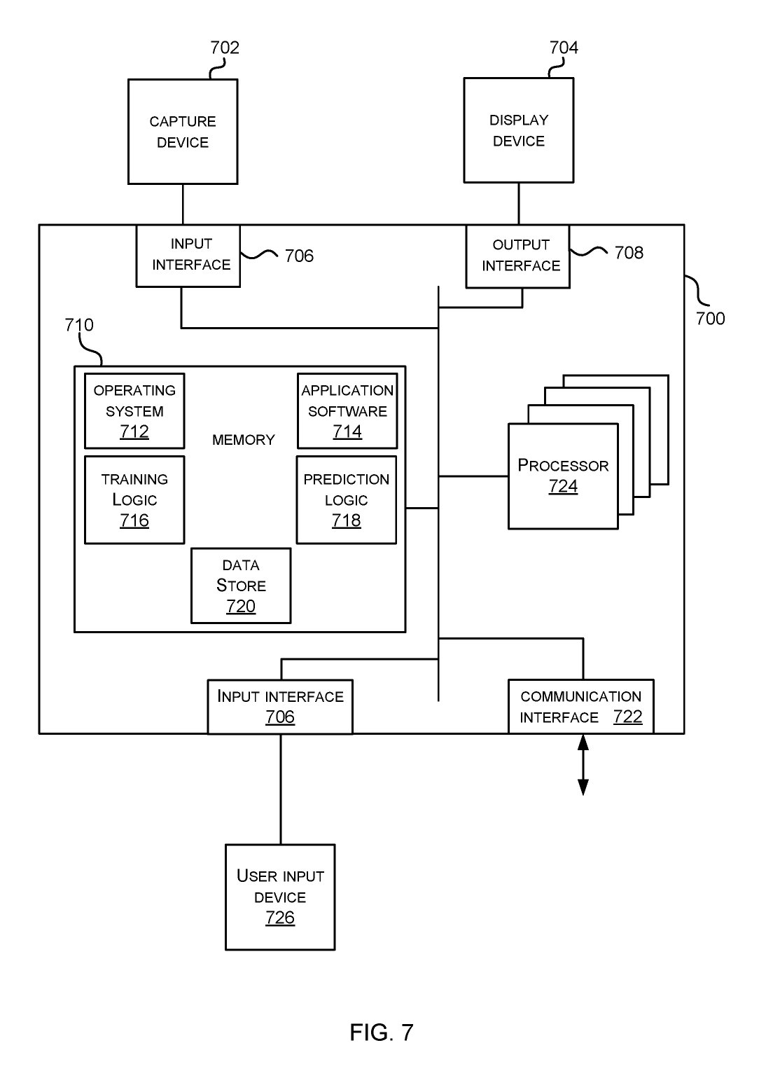

FIG. 7 illustrates various components of an exemplary computing-based device 700 which may be implemented as any form of a computing and/or electronic device, and in which embodiments of random decision trees/forests with improved generalization ability may be implemented for medical image analysis, gesture recognition, speech processing and other purposes.

Computing-based device 700 comprises one or more processors 724 which may be microprocessors, controllers, graphics processing units, parallel processing units, or any other suitable type of processors for processing computing executable instructions to control the operation of the device in order to compute predictions from sensor data items, and/or train random decision trees or forests. In some examples, for example where a system on a chip architecture is used, the processors 724 may include one or more fixed function blocks (also referred to as accelerators) which implement a part of the method of making predictions from sensor data items in hardware (rather than software or firmware).

The computing-based device 700 comprises one or more input interfaces 706 arranged to receive and process input from one or more devices, such as user input devices (e.g. capture device 702, a game controller, a keyboard and/or a mouse). This user input may be used to control software applications or games executed on the computing device 700.

The computing-based device 700 also comprises an output interface 708 arranged to output display information to a display device 704 which can be separate from or integral to the computing device 700. The display information may provide a graphical user interface. In an example, the display device 704 may also act as the user input device if it is a touch sensitive display device. The output interface may also output data to devices other than the display device, e.g. a locally connected printing device.

The computer executable instructions may be provided using any computer-readable media that is accessible by computing based device 700. Computer-readable media may include, for example, computer storage media such as memory 710 and communications media. Computer storage media, such as memory 710, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Although the computer storage media (memory 710) is shown within the computing-based device 700 it will be appreciated that the storage may be distributed or located remotely and accessed via a network or other communication link (e.g. using communication interface 722).

Platform software comprising an operating system 712 or any other suitable platform software may be provided at the computing device 700 to enable application software 714 to be executed on the device. Other software that can be executed on the computing device 700 includes: tree training logic 716 (see for example, FIGS. 3-5 and description above); prediction logic 718 (see for example FIG. 6 and description above). A data store 720 is provided to store data such as sensor data, split node parameters, intermediate function results, tree training parameters, probability distributions, classification labels, regression objectives, classification objectives, and other data.

Alternatively or in addition to the other examples described herein, examples include any combination of the following:

A computer-implemented method of training a random decision tree comprising:

at a split node of the random decision tree;
dividing, using a processor, a plurality of training sensor data elements available at the split node, into a tuning set and a validation set;
forming, using the tuning set, a plurality of models each model using different values of parameters of the split node;
computing performance of the models at splitting the validation set between left and right child nodes of the split node; and
selecting one of the models on the basis of the computed performance and storing the parameters of the selected model in association with the split node.

The parameters of the selected model are stored in association with the split node and become part of a trained random decision tree created using the method. The method repeats for each split node of the decision tree so that the parameters of each split node are learnt and stored. As a result of using the tuning and validation sets as claimed a trained random decision tree is produced which has good generalization performance. The selection of a model at a split node is made on the basis of the computed performance, for example, by selecting the model with the best performance or a high ranking performance. Various different performance metrics may be used as mentioned in the paragraph immediately below.

The method described above comprising using the random decision tree to classify image elements of an image by passing the image elements through the random decision tree according to results of a test performed at the split node using the selected model.

The method described above comprising computing the performance using any one or more of: information gain, variance reduction, Gini entropy, or the ‘two-ing’ criterion.

The method described above comprising training the random decision tree to a specified depth and pruning split nodes of the random decision tree on the basis of the computed performance.

The method described above comprising iteratively training the random decision tree to a specified depth and pruning the split nodes on the basis of the computed performance.

The method described above wherein a random division is used to divide the plurality of training sensor data elements available at the split node into the tuning set and the validation set.

The method described above which is repeated for a plurality of split nodes of the random decision tree.

The method described above comprising forming the plurality of models from the tuning set by randomly selecting combinations of values of the parameters and assessing performance of the models used at the split node to divide the tuning set.

The method described above comprising computing the performance using any one or more of: information gain, variance reduction, Gini entropy, or the ‘two-ing’ criterion.

The method described above which is carried out for each of a plurality of random decision trees which together form a random decision forest.

The method described above wherein the sensor data elements are elements of a medical image and wherein the method is for training the random decision tree to detect body organs in medical images.

A training system for training a random decision tree comprising:

a memory storing a random decision tree;
a processor arranged to, at a split node of the random decision tree:
divide a plurality of training sensor data elements available at the split node, into a tuning set and a validation set;
form, using the tuning set, a plurality of models each model using different values of parameters of the split node;
compute performance of the models at splitting the validation set between left and right child nodes of the split node; and
select one of the models on the basis of the computed performance and store the parameters of the selected model in association with the split node in the memory.

The training system described above wherein the processor is arranged to compute the performance using any one or more of: information gain, variance reduction, Gini entropy, or the ‘two-ing’ criterion.

The training system described above wherein the processor is arranged to train the random decision tree to a specified depth and prune split nodes of the random decision tree on the basis of the computed performance

The training system described above wherein the processor is arranged to iteratively training the random decision tree to a specified depth and prune the split nodes on the basis of the computed performance.

The training system described above wherein the processor is arranged to compute a random division to divide the plurality of training sensor data elements available at the split node into the tuning set and the validation set.

The training system described above which operates for a plurality of split nodes of the random decision tree.

The training system described above wherein the processor is arranged to form the plurality of models from the tuning set by randomly selecting combinations of values of the parameters and assessing performance of the models used at the split node to divide the tuning set.

The training system described above wherein the processor is arranged to compute the performance using any one or more of: information gain, variance reduction, Gini entropy, or the ‘two-ing’ criterion.

The training system described above which is arranged to train each of a plurality of random decision trees which together form a random decision forest.

A machine learning system comprising:

a memory storing a random decision tree comprising a root node, a plurality of split nodes, and a plurality of leaf nodes, the split nodes having parameter values;
wherein the parameter values of the split nodes have been obtained by:
dividing a plurality of training examples available at the split node, into a tuning set and a validation set;
forming, using the tuning set, a plurality of models each model using different values of parameters of the split node; and
selecting one of the models by on the basis of performance of the models at splitting the validation set between left and right child nodes of the split node.

In an example there is a machine learning system comprising a random decision tree and with means for, at a split node of the random decision tree,

dividing a plurality of training sensor data elements available at the split node, into a tuning set and a validation set;

forming, using the tuning set, a plurality of models each model using different values of parameters of the split node;

computing performance of the models at splitting the validation set between left and right child nodes of the split node; and

selecting one of the models on the basis of the computed performance and storing the parameters of the selected model in association with the split node.

For example, the means for dividing, forming, computing, selecting and storing comprises the training logic of FIG. 7 when encoded to carry out the operations of any of FIGS. 3 to 5.

A computer-implemented method at an image processing system comprising:

accessing a plurality of training images;
storing a random decision tree at a memory of the image processing system;

at a split node of the random decision tree:

dividing, using a processor, a plurality of elements of the training images which have flowed through the random decision tree to the split node, into a tuning set and a validation set;

forming, using the tuning set, a plurality of models each model using different values of parameters of the split node;

computing performance of the models at splitting the validation set between left and right child nodes of the split node; and

selecting one of the models on the basis of the computed performance and storing the parameters of the selected model in association with the split node.

An image processing system comprising:

a memory storing a random decision tree;

a processor arranged to, at a split node of the random decision tree:
divide a plurality of training image elements available at the split node, into a tuning set and a validation set;
form, using the tuning set, a plurality of models each model using different values of parameters of the split node;
compute performance of the models at splitting the validation set between left and right child nodes of the split node; and
select one of the models on the basis of the computed performance and store the parameters of the selected model in association with the split node in the memory.

An image processing system comprising:

a memory storing a random decision tree comprising a root node, a plurality of split nodes, and a plurality of leaf nodes, the split nodes having parameter values;
wherein the parameter values of the split nodes have been obtained by:

dividing a plurality of training image elements available at the split node, into a tuning set and a validation set;

forming, using the tuning set, a plurality of models each model using different values of parameters of the split node; and

selecting one of the models by on the basis of performance of the models at splitting the validation set between left and right child nodes of the split node.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. A computer-implemented method of training a random decision tree comprising:
at a split node of the random decision tree:
dividing, using a processor, a plurality of training sensor data elements available at the split node, into a tuning set and a validation set;
forming, using the tuning set, a plurality of models each model using different values of parameters of the split node;
computing performance of the models at splitting the validation set between left and right child nodes of the split node; and
selecting one of the models on the basis of the computed performance and storing the parameters of the selected model in association with the split node.

2. The method of claim 1 comprising using the random decision tree to classify image elements of an image by passing the image elements through the random decision tree according to results of a test performed at the split node using the selected model.

3. The method of claim 1 comprising computing the performance using any one or more of: information gain, variance reduction, Gini entropy, or the ‘two-ing’ criterion.

4. The method of claim 1 comprising training the random decision tree to a specified depth and pruning split nodes of the random decision tree on the basis of the computed performance.

5. The method of claim 4 comprising iteratively training the random decision tree to a specified depth and pruning the split nodes on the basis of the computed performance.

6. The method of claim 1 wherein a random division is used to divide the plurality of training sensor data elements available at the split node into the tuning set and the validation set.

7. The method of claim 1 which is repeated for a plurality of split nodes of the random decision tree.

8. The method of claim 1 comprising forming the plurality of models from the tuning set by randomly selecting combinations of values of the parameters and assessing performance of the models used at the split node to divide the tuning set.

9. The method of claim 8 comprising computing the performance using any one or more of: information gain, variance reduction, Gini entropy, or the ‘two-ing’ criterion.

10. The method of claim 1 which is carried out for each of a plurality of random decision trees which together form a random decision forest.

11. The method of claim 1 wherein the sensor data elements are elements of a medical image and wherein the method is for training the random decision tree to detect body organs in medical images.

12. A training system for training a random decision tree comprising:
a memory storing a random decision tree;
a processor arranged to, at a split node of the random decision tree:
divide a plurality of training sensor data elements available at the split node, into a tuning set and a validation set;
form, using the tuning set, a plurality of models each model using different values of parameters of the split node;
computing performance of the models at splitting the validation set between left and right child nodes of the split node; and
select one of the models on the basis of the computed performance and store the parameters of the selected model in association with the split node in the memory.

13. The training system of claim 12 wherein the processor is arranged to compute the performance using any one or more of: information gain, variance reduction, Gini entropy, or the ‘two-ing’ criterion.

14. The training system of claim 12 wherein the processor is arranged to train the random decision tree to a specified depth and prune split nodes of the random decision tree on the basis of the computed performance

15. The training system of claim 14 wherein the processor is arranged to iteratively training the random decision tree to a specified depth and prune the split nodes on the basis of the computed performance.

16. The training system of claim 12 wherein the processor is arranged to compute a random division to divide the plurality of training sensor data elements available at the split node into the tuning set and the validation set.

17. The training system of claim 12 wherein the processor is arranged to form the plurality of models from the tuning set by randomly selecting combinations of values of the parameters and assessing performance of the models used at the split node to divide the tuning set.

18. The training system of claim 12 wherein the processor is arranged to compute the performance using any one or more of: information gain, variance reduction, Gini entropy, or the ‘two-ing’ criterion.

19. The training system of claim 12 which is arranged to train each of a plurality of random decision trees which together form a random decision forest.

20. A machine learning system comprising:
a memory storing a random decision tree comprising a root node, a plurality of split nodes, and a plurality of leaf nodes, the split nodes having parameter values;
wherein the parameter values of the split nodes have been obtained by:
dividing a plurality of training examples available at the split node, into a tuning set and a validation set;
forming, using the tuning set, a plurality of models each model using different values of parameters of the split node; and
selecting one of the models by on the basis of performance of the models at splitting the validation set between left and right child nodes of the split node.
